(19) United States
(12) Patent Application Publication
(10) Pub. No.: US 2003/0078749 A1
(43) Pub. Date: Apr. 24, 2003

(54) Memory module with integrated radio transmitter

(76) Inventors: Hans Eberle, Mountain View, CA (US); Jose M. Cruz-Albrecht, Palo Alto, CA (US); Neil C. Wilhelm, Menlo Park, CA (US)

Correspondence Address: HOYT A. FLEMING III, P.O. BOX 140678, BOISE, ID, 83714, US

(21) Appl. No.: 09/981,960

(22) Filed: Oct. 18, 2001

(51) Int. Cl. G06F 19/00

(52) U.S. Cl. 702/80

(57) ABSTRACT

A memory module for storing data. The memory module includes: a circuit board that has a plurality of electrical terminals; a volatile memory device that is mounted on the circuit board; and a radio transmitter that is mounted on the circuit board. The radio transmitter is operable to transmit information.

### 1. FIELD OF THE INVENTION

The present invention generally relates to electronic devices. More specifically, the present invention relates to memory modules.

### 2. BACKGROUND

In today's computer systems, a computer's main memory typically includes a number of memory modules, such as dual in-line memory modules (DIMMs). These memory modules include a number of memory chips mounted on a circuit board. A diagram of a prior art memory module 101 is shown in FIG. 1. A memory module circuit board 105 electrically connects the terminals of the memory chips 110 to a plurality of edge connectors 115, i.e., terminals located on an edge of the circuit board 105. Memory modules are typically plugged into memory slots, which electrically connect the edge connectors 115 of the memory module to other units within the computer system.

Computer designers may choose from numerous available, standardized memory modules of various types, sizes and configurations. If a memory module can provide information identifying the type and size of the memory module to external circuitry, then computer systems can be designed that are compatible with a wide variety of memory modules. Other components of the computer system can access the information identifying the memory module (“memory module information”) and can interact with the memory module accordingly.

There exist numerous and well-known ways of storing memory module information. One such way is to provide a plurality of jumpers (not shown) on the circuit board, the state of each of the jumpers indicating by binary code the type, size and configuration of memory module contained on the circuit board. Alternatively, a non-volatile memory device, such as a Serial EEPROM (SEEPROM) 120 can be preprogrammed with an identifying code, and then mounted on the circuit board together with the volatile RAM units, such as dynamic random access memory devices (DRAMs). When a computer boots, the SEEPROMs, via an I²C bus, communicate the memory module information from the memory module to the computer system.

As is well known, SEEPROMs used on PC 100 memory modules contain three address pins, which determine the device address of the SEEPROM. These pins are coupled to corresponding edge connectors, which receive hard-wired address signals that are associated with a given memory slot. Thus, by querying a SEEPROM with an address that is associated with a memory slot, the computer system is able to obtain the memory module information from a memory module that is located in a given memory slot. The received memory module information is utilized to configure a memory controller to communicate with the volatile memory devices on the memory module.

As the number of memory modules in computer systems increases, in some cases the number of address pins is not sufficient to uniquely identify a large number of memory modules. Thus, an efficient method of obtaining memory module information from a large number of memory modules is needed.

### 3. SUMMARY OF INVENTION

One embodiment of the invention is a memory module for storing data. The memory module includes: a circuit board that has a plurality of electrical terminals; a volatile memory device that is mounted on the circuit board; and a radio transmitter that is mounted on the circuit board. The radio transmitter is operable to transmit information.

Another embodiment of the invention is another memory module for storing data. This memory module includes: a circuit board having a plurality of electrical terminals; a volatile memory device mounted on the circuit board; and a radio transmitter mounted on the circuit board. The radio transmitter includes a non-volatile memory cell for storing memory module information. The radio transmitter can transmit at least a portion of the memory module information to a radio receiver.

Still another embodiment of the invention is a computer system for processing data. The computer system includes a memory module for storing data. The memory module includes: a circuit board having a plurality of electrical terminals; a volatile memory device mounted on the circuit board; and a radio transmitter mounted on the circuit board. The radio transmitter can transmit information. The computer system also includes a radio receiver that can receive the information from the radio transmitter.

Yet another embodiment of the invention is a computer system that includes a memory module for storing data. The memory module includes: a circuit board having a plurality of electrical terminals; a volatile memory device mounted on the circuit board; a non-volatile memory device mounted on the circuit board and storing memory module information; and a radio transmitter mounted on the circuit board. The radio transmitter can receive at least a portion of the memory module information from the non-volatile memory device and transmit at least a portion of the memory module information. The computer system also includes a radio receiver that is operable to receive at least a portion of the memory module information from the radio transmitter.

### 4. BRIEF DESCRIPTION OF THE FIGURES

FIG. 1 presents a prior art memory module.

FIG. 2 presents a memory module.

FIG. 3 presents another memory module

FIG. 4 presents a computer system.

FIG. 5 presents a method of determining the location of a memory module.

FIG. 6 presents another computer system.

FIG. 7 presents another method of determining the location of a memory module.

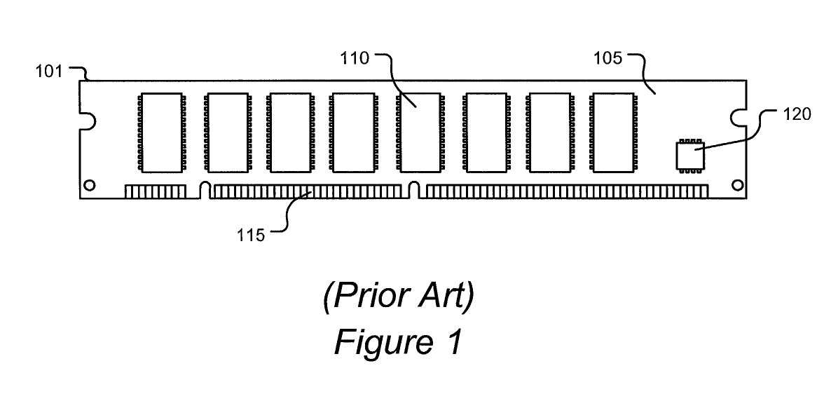

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### 5.1 Memory Module with a Radio Transmitter

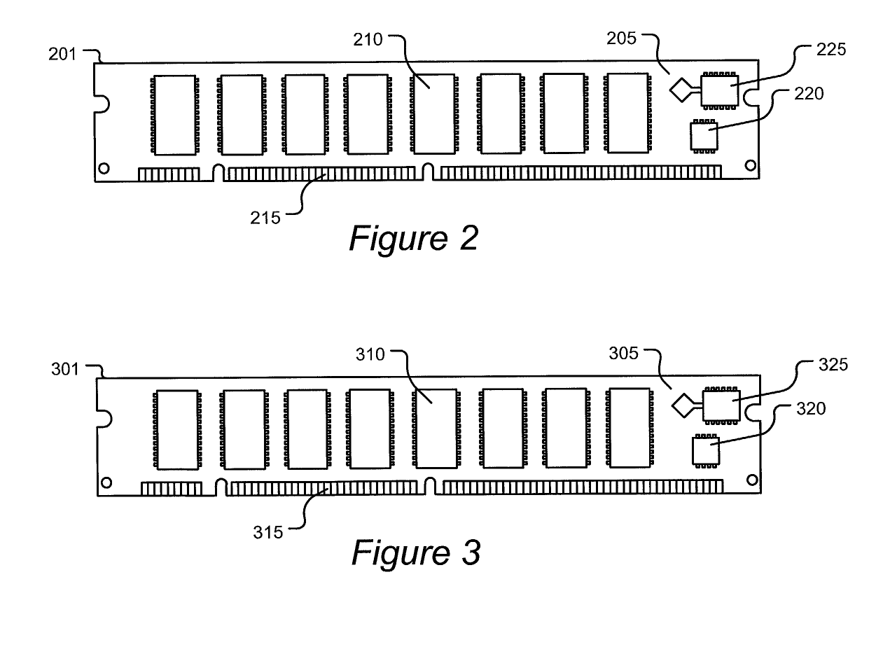

One embodiment of the invention is a memory module that can transfer memory module information from the memory module via a radio transmitter. The memory module includes a plurality of volatile memory devices for storing data, a non-volatile memory device for storing memory module information, and a radio transmitter that can receive the memory module information from the non-volatile memory device and then transmit such memory module information to a radio receiver in a computer system. After the memory module information is received, then it can be utilized to program a memory controller, so that the memory controller can communicate with the memory module's volatile memory. Such a memory module is presented in FIG. 2.

FIG. 2 presents a memory module 201 that includes a circuit board 205 with a plurality of edge connectors 215. A plurality of volatile memory devices 210 are mounted on the circuit board 205. In some embodiments of the invention, the volatile memory devices 210 are dynamic random access memory (DRAM) devices. In other embodiments of the invention, the volatile memory devices 210 are synchronous dynamic random access memory (SDRAM) devices, double data rate (DDR) memory devices, double data rate 2 (DDR2) memory devices, or RAMBUS dynamic random access memory (RDRAM) devices.

Referring again to FIG. 2, a non-volatile memory device 220 is also mounted on the circuit board 205. In some embodiments of the invention, the non-volatile memory device 220 is an electrically programmable read only memory (EPROM), an electrically erasable programmable read only memory (EEPROM), or a serial electrically erasable programmable read only memory (SEEPROM). The non-volatile memory device 220 stores information that relates to the memory module (“memory module information”). For example, in some embodiments of the invention, the non-volatile memory device 220 would store information relating to the size of the memory module. Such information may include one or more of the following: the number of row addresses on the memory module, the number of column addresses on the memory module, the number of module rows on the memory module, the number of banks on the memory module, and/or the data width of the memory module. Detailed information relating to such information may be found in Intel's PC SDRAM Serial Presence Detect (SPD) Specification, Revision 1.2B (http://developer.intel.com/technology/memory/pc133sdram/spec/spdsd12b.htm), which is hereby incorporated by reference. In other embodiments of the invention, the non-volatile memory device 220 would also store information related to the configuration of the memory module and the type and/or speed of volatile memory devices present on the memory module. As shown in FIG. 2, a radio (RF) transmitter 225 is also mounted on the circuit board 205. The radio transmitter 225 can receive information from the non-volatile memory device 220. In some embodiments of the invention, the radio transmitter 225 receives the information from the non-volatile memory device 220 via an I²C bus. After receiving such information, the radio transmitter 225 can then transmit the information to a radio receiver that would typically be located within the computer system.

### 5.2 Memory Module with a Radio Transceiver

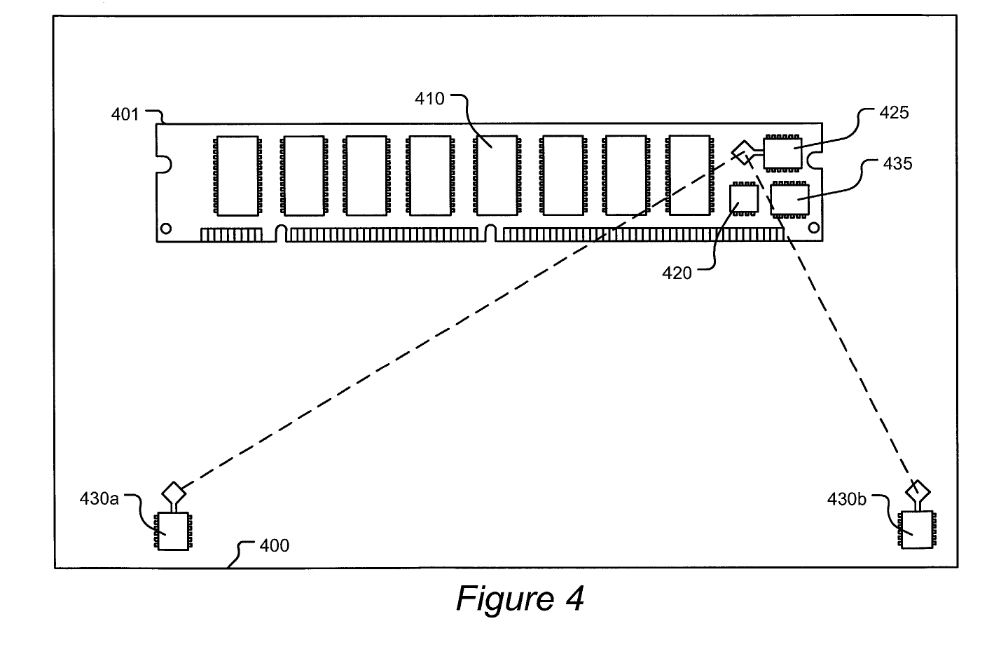

In some embodiments of the invention, such as shown in FIG. 3, the memory module 301 includes a radio transceiver 325. In such embodiments, the radio transceiver 325 can send radio signals to and receive radio signals from one or more radio transmitters or transceivers. For example, as shown in FIG. 4, a radio transceiver 425 can receive radio signals from two radio transceivers 430a and 430b.

### 5.3 One Method of Determining the Location of a Memory Module

Some embodiments of the invention utilize the signal strengths and/or propagation delays of radio signals to determine the identity of the memory slot in which a memory module is located. Thus, the memory module can determine the memory module's “location” within the computer system. After the memory module location has been determined, then the memory module can provide its location and its memory module information to the computer system. Then, the computer system can program its memory controller to communicate with the memory module's volatile memory devices.

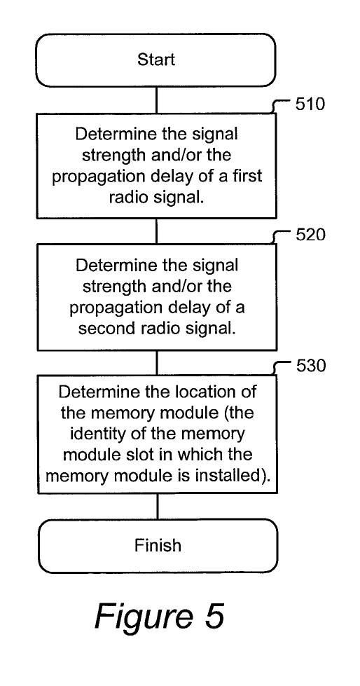

Referring to FIG. 4, a computer system 400 is shown that includes a memory module 401. The memory module 401 includes a processor 435 in addition to a non-volatile memory device 420, and radio transceiver 425. The processor 435 may be a microprocessor, a microcontroller, a digital signal processor, or any similar device. In some embodiments of the invention, the processor 435 is programmed to perform the method shown in FIG. 5.

Referring to Block 510 of FIG. 5, the processor 435 first determines, using methods known by those skilled in the art, the signal strength and/or the propagation delay of a radio signal received from a first radio transmitter, such as radio transmitter 430a. Next, referring to Block 520 of FIG. 5, the processor 435 determines the signal strength and/or the propagation delay of a radio signal received from a second radio transmitter, such as radio transmitter 430b. Referring to Block 530 of FIG. 5, after determining the signal strengths and/or the propagation delays, the processor 435 then, utilizing methods known in the art, determines the location of the memory module 401 based upon the determined signal strengths and/or propagation delays. In other words, by determining the two signal strengths and/or propagation delays, the processor 435 can determine the identity of the memory module slot in which the memory module 401 is located.

After the location of the memory module 401 is determined, then the memory module can transmit its location and the memory module information to a radio transceiver 430a and/or 430b. Then, a memory controller can be programmed to communicate with the memory module's volatile memory devices 410.

### 5.4 Memory Module with Radio Transmitter that Includes Non-Volatile Memory

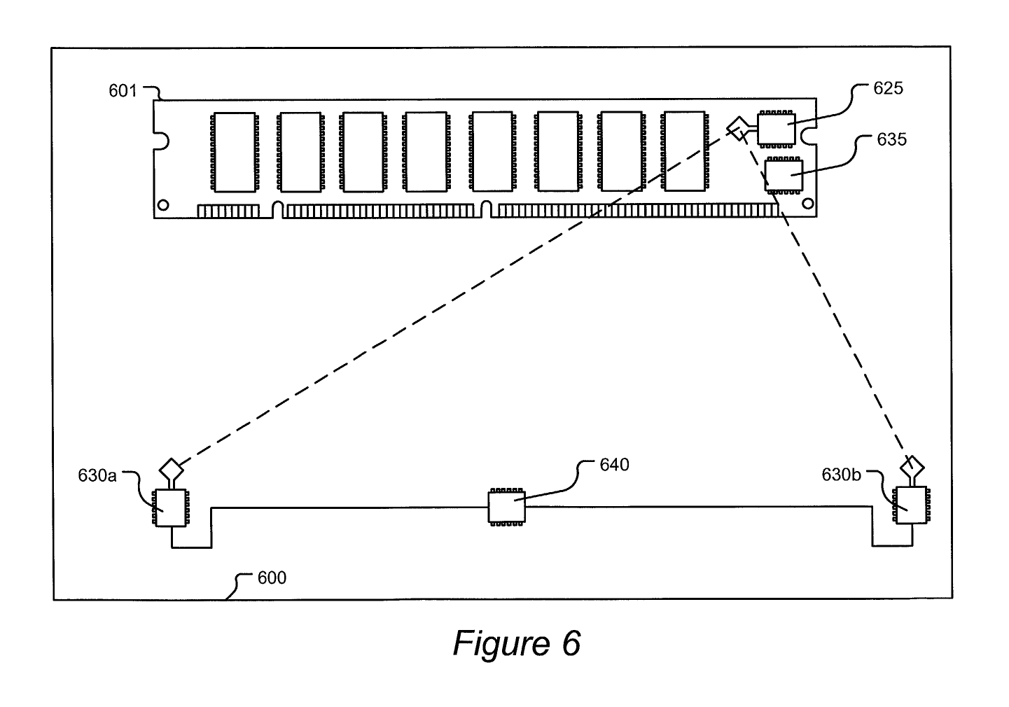

FIG. 6 presents a memory module 601 that includes a radio transceiver 625. This radio transceiver 625 includes a plurality of non-volatile memory cells for storing memory module information, such as was discussed in Section 5.1 with reference to Intel's PC SDRAM Serial Presence Detect (SPD) Specification, Revision 1.2B. Because the radio transceiver 625 includes non-volatile memory cells for storing memory module information, there is no need for a separate non-volatile memory device. As a result, the complexity and cost of the memory module 601 can be reduced.

In some embodiments of the invention, the radio transceiver 625 also includes the ability to determine signal strength and/or propagation delays of radio signals from one or more radio transmitters. Further, in some embodiments of the invention, the radio transceiver 625 includes the ability to determine the location of the memory module based upon the determined signal strengths and/or propagation delays of the radio signals received from one or more radio transmitters such as radio transceivers 630a and 630b.

### 5.5 Another Method of Determining the Location of a Memory Module

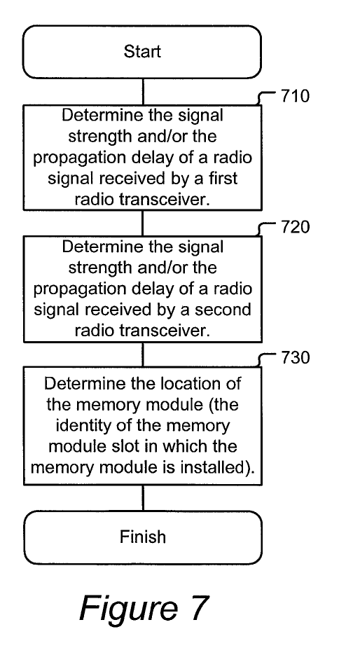

In several of the above-described embodiments of the invention, a processor (or the radio transceiver that includes processing capabilities) that is mounted on the circuit board of a memory module determines the location of the memory module by first determining the signal strength and/or propagation delay of a one or more radio signals that originate from one or more radio transmitters that are mounted on other circuit board(s) within the computer system. However, in other embodiments of the invention, a processor that is not mounted on a memory module can determine the signal strength and/or propagation delays of radio signal(s) transmitted by the memory module and can determine the location of the memory module. For example, such a processor may be mounted on a computer's motherboard or on a server computer's memory board that includes numerous memory slots for memory modules. In some embodiments of the invention, the processor is programmed to perform the method shown in FIG. 7.

Referring to Block 710 of FIG. 7, a processor 640 that is coupled to radio transceivers 630a and 630b, determines the signal strength and/or the propagation delay of a radio signal transmitted from the memory module 601 and received by the first radio transceiver 630a. Similarly, referring to Block 710 of FIG. 7, the processor 640 determines the signal strength and/or the propagation delay of a radio signal transmitted from the memory module 601 and received by the second radio transceiver 630b. Next, referring to Block 730 of FIG. 7, based upon the determined signal strengths and/or propagation delays, the processor 640 determines the location of the memory module 601.

In some embodiments of the invention, the radio transceiver 635 on the memory module 601 would transmit a single radio signal. This radio signal would be received by both radio transceivers 630a and 630b. The processor would then determine the location of the memory module 601 based upon the determined signal strengths and/or propagation delays.

However, in other embodiments of the invention, a first radio signal would be transmitted from the radio transceiver 635 on the memory module 601 to the first radio transceiver 630a. Then, a second radio signal would be transmitted from the radio transceiver 635 to the second radio transceiver 630b. As a result, the processor 640 would determine the location of the memory module 601 based upon the received signals. In still other embodiments (not shown), one processor would be coupled to the first transceiver 635a and a second processor would be coupled to the second transceiver 635b. In such embodiments, the first processor would determine the signal strength and/or propagation delay of a radio signal received by the first transceiver 635a and the second processor make such determinations for radio signals received by the second transceiver 635b.

### 5.6 Additional Uses for a Radio Transmitter on a Memory Module

In addition to transferring the location of the memory module and the memory information from the memory module to the computer system, a radio transceiver on a memory module can also transfer diagnostic information. For example, a processor on a memory module could perform diagnostic tests such as a memory self-test, an interconnect test, and/or an error correction code test. If such a test fails, then data indicating the failure could be reported via the radio transmitter.

During a memory self-test, the processor could write various test patterns to the memory module's volatile memory devices and then compare the data read from the devices with the test patterns. If an error is found, then the error could be reported via the radio transceiver on the memory module.

To test the interconnect, test patterns are exchanged via the edge connector between a memory module and either another memory module or a memory controller. In this application, the radio transceiver could be used to transfer information needed to set up the test and report test results.

In addition, the radio transmitter could be used to report errors found when checking checksums received when information is sent to the memory module via the edge connector or when checking checksums stored along with the data in the volatile memory.

### 5.7 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

It is claimed:

1. A memory module for storing data, including:
a) a circuit board having a plurality of electrical terminals;
b) a volatile memory device mounted on the circuit board; and
c) a radio transmitter mounted on the circuit board, the radio transmitter operable to transmit information.

2. A memory module for storing data, comprising:
a) a circuit board having a plurality of electrical terminals;
b) a volatile memory device mounted on the circuit board;
c) a non-volatile memory device mounted on the circuit board, the non-volatile memory device storing memory module information; and
d) a radio transmitter mounted on the circuit board, the radio transmitter operable to receive at least a portion of the information from the non-volatile memory device and transmit the at least a portion of the memory module information to a radio receiver.

3. The memory module of claim 2, wherein the volatile memory device is a dynamic random access memory (DRAM) device.

4. The memory module of claim 2, wherein the volatile memory device is a synchronous dynamic random access memory (SDRAM) device.

5. The memory module of claim 2, wherein the non-volatile memory device is an electrically programmable read only memory (EPROM).

6. The memory module of claim 2, wherein the non-volatile memory device is an electrically erasable programmable read only memory (EEPROM).

7. The memory module of claim 2, wherein the non-volatile memory device is a serial electrically erasable programmable read only memory (SEEPROM).

8. The memory module of claim 2, wherein the non-volatile memory is connected to the radio transmitter via an I²C bus.

9. The memory module of claim 2, wherein the radio transmitter is a radio transceiver.

10. The memory module of claim 9, further comprising:
e) a processor that is mounted on the circuit board, the processor being operable to determine the signal strength of a radio signal received from a radio transmitter.

11. The memory module of claim 9, further comprising:
e) a processor that is mounted on the circuit board, the processor being operable to determine the propagation delay of a radio signal received from a radio transmitter.

12. The memory module of claim 9, wherein the radio transceiver is operable to receive radio signals from a first radio transmitter and a second radio transmitter.

13. The memory module of claim 9, further comprising:
e) a processor that is mounted on the circuit board, the processor being operable to determine the signal strength of a radio signal received from a first transmitter and the signal strength of a radio signal received from a second transmitter.

14. The memory module of claim 9, further comprising:
e) a processor that is mounted on the circuit board, the processor being operable to determine the signal strength of a radio signal received from a first transmitter, the signal strength of a radio signal received from a second transmitter, and the location of the memory module based upon the determined signal strengths.

15. The memory module of claim 9, further comprising:
e) a processor that is mounted on the circuit board, the processor being operable to determine the propagation delay of a radio signal received from a first transmitter and the propagation delay of a radio signal received from a second transmitter.

16. The memory module of claim 9, further comprising:
e) a processor that is mounted on the circuit board, the processor being operable to determine the propagation delay of a radio signal received from a first transmitter, the propagation delay of a radio signal received from a second transmitter, and the location of the memory module based upon the determined signal propagation delays.

17. The memory module of claim 9, further comprising:
e) a processor that is mounted on the circuit board, the processor being operable to determine the signal strength and the propagation delay of a radio signal received from a first transmitter and the signal strength and the propagation delay of a radio signal received from a second transmitter.

18. The memory module of claim 9, further comprising:
e) a processor that is mounted on the circuit board, the processor being operable to determine the signal strength and the propagation delay of a radio signal received from a first transmitter, the signal strength and the propagation delay of a radio signal received from a second transmitter, and the location of the memory module based upon the determined signal strengths and propagation delays.

19. A memory module for storing data, comprising:
a) a circuit board having a plurality of electrical terminals;
b) a volatile memory device mounted on the circuit board; and
c) a radio transmitter mounted on the circuit board, the radio transmitter including a non-volatile memory cell for storing memory module information, the radio transmitter being operable to transmit at least a portion of the memory module information to a radio receiver.

20. The memory module of claim 19, wherein the radio transmitter is a radio transceiver.

21. The memory module of claim 20, further comprising:
d) a processor that is mounted on the circuit board, the processor being operable to determine the signal strength of a radio signal received from a radio transmitter.

22. The memory module of claim 20, further comprising:
d) a processor that is mounted on the circuit board, the processor being operable to determine the propagation delay of a radio signal received from a radio transmitter.

23. The memory module of claim 20, wherein the radio transceiver is operable to receive radio signals from a first radio transmitter and a second radio transmitter.

24. The memory module of claim 20, further comprising:
d) a processor that is operable to determine the signal strength of a radio signal received from a first transmitter and the signal strength of a radio signal received from a second transmitter.

25. The memory module of claim 20, further comprising:
d) a processor that is operable to determine the signal strength of a radio signal received from a first transmitter, the signal strength of a radio signal received from a second transmitter, and the location of the memory module based upon the determined signal strengths.

26. The memory module of claim 20, further comprising:
d) a processor that is operable to determine the propagation delay of a radio signal received from a first transmitter and the propagation delay of a radio signal received from a second transmitter.

27. The memory module of claim 20, further comprising:
d) a processor that is operable to determine the propagation delay of a radio signal received from a first transmitter, the propagation delay of a radio signal received from a second transmitter, and the location of the memory module based upon the determined signal propagation delays.

28. The memory module of claim 20, further comprising:
d) a processor that is operable to determine the signal strength and the propagation delay of a radio signal received from a first transmitter and the signal strength and the propagation delay of a radio signal received from a second transmitter.

29. The memory module of claim 20, further comprising:
d) a processor that is operable to determine the signal strength and the propagation delay of a radio signal received from a first transmitter, the signal strength and the propagation delay of a radio signal received from a second transmitter, and the location of the memory module based upon the determined signal strengths and propagation delays.

30. A computer system for processing data, comprising:
a) a memory module for storing data, including:
1) a circuit board having a plurality of electrical terminals;
2) a volatile memory device mounted on the circuit board;
3) a radio transmitter mounted on the circuit board, the radio transmitter operable to transmit information; and
b) a radio receiver that is operable to receive the information from the radio transmitter.

31. The computer system of claim 30 wherein the radio receiver is coupled to a processor that is operable to determine the signal strength of a radio signal transmitted from the radio transmitter.

32. The computer system of claim 30, wherein the radio receiver is coupled to a processor that is operable to determine the propagation delay of a radio signal transmitted from the radio transmitter.

33. The computer system of claim 30, wherein the radio receiver is coupled to a processor that is operable to determine the signal strength and the propagation delay of a radio signal transmitted from the radio transmitter.

34. The computer system of claim 30, wherein the radio receiver is coupled to a processor that is operable to determine the location of the memory module.

35. A computer system comprising:
a) a memory module for storing data, including:
1) a circuit board having a plurality of electrical terminals;
2) a volatile memory device mounted on the circuit board;
3) a non-volatile memory device mounted on the circuit board and storing memory module information; and
4) a radio transmitter mounted on the circuit board, the radio transmitter operable to receive at least a portion of the memory module information from the non-volatile memory device and transmit the at least a portion of the memory module information; and
b) a radio receiver that is operable to receive the at least a portion of the memory module information from the radio transmitter.

36. The computer system of claim 35, wherein the radio receiver is coupled to a processor that is operable to determine the signal strength of a radio signal transmitted from the radio transmitter.

37. The computer system of claim 35, wherein the radio receiver is coupled to a processor that is operable to determine the propagation delay of a radio signal transmitted from the radio transmitter.

38. The computer system of claim 35, wherein the radio receiver is coupled to a processor that is operable to determine the signal strength and the propagation delay of a radio signal transmitted from the radio transmitter.

39. The computer system of claim 35, wherein the radio receiver is coupled to a processor that is operable to determine the location of the memory module.

40. A method of determining the size of a memory module in a computer system, comprising:
a) transmitting memory module information from a radio transmitter that is mounted on the circuit board of the memory module to a radio receiver;
b) receiving the memory module information with a radio receiver; and
c) utilizing the received memory module information to determine the size of the memory module.

41. The method of claim 40, further comprising:
d) using the received memory module information to configure a memory controller.

42. A method of determining a characteristic of a memory module in a computer system, comprising:
a) transmitting memory module information from a radio transmitter that is mounted on the circuit board of the memory module to a radio receiver;
b) receiving the memory module information with a radio receiver; and
c) utilizing the received memory module information to determine the characteristic of the memory module.

43. The method of claim 42, further comprising:
d) using the received memory module information to configure a memory controller.

44. A method of determining the location of a memory module within a computer system, comprising:
a) determining the signal strength of a radio signal; and
b) based upon the determined signal strength, determining the location of the memory module.

45. A method of determining the location of a memory module within a computer system, comprising:
a) determining the signal strength of a first radio signal;
b) determining the signal strength of a second radio signal; and
c) based upon the determined signal strengths, determining the location of the memory module.

46. A method of determining the location of a memory module within a computer system, comprising:
a) determining the propagation delay of a radio signal; and
b) based upon the determined propagation delay, determining the location of the memory module.

47. A method of determining the location of a memory module within a computer system, comprising:
a) determining the propagation delay of a first radio signal;
b) determining the propagation delay of a second radio signal; and
c) based upon the determined propagation delays, determining the location of the memory module.

48. The memory module of claim 1, wherein the radio transmitter is operable to transmit information that indicates that the memory module failed a test.

49. The memory module of claim 1, wherein the radio transmitter is operable to transmit information that indicates that the memory module failed self-test.

50. The memory module of claim 1, wherein the radio transmitter is operable to transmit information that indicates that the memory module failed an interconnect test.

51. The memory module of claim 1, wherein the radio transmitter is operable to transmit information that indicates that the memory module failed an error correction code test.
